(19) United States
(12) Patent Application Publication
(10) Pub. No.: US 2010/0235236 A1
(43) Pub. Date: Sep. 16, 2010

(54) SYSTEM AND METHOD FOR CREATING AND USING ADVERTISEMENTS DATABASE

(76) Inventors: Gil HALEVI, Karmiel (IL); Alon Yaacov Kahn, Lavon (IL)

Correspondence Address: ARENT FOX LLP, 1050 CONNECTICUT AVENUE, N.W., SUITE 400, WASHINGTON, DC, 20036, US

(21) Appl. No.: 12/537,793

(22) Filed: Aug. 7, 2009

Related U.S. Application Data
(60) Provisional application No. 61/087,638, filed on Aug. 9, 2008.

(51) Int. Cl. G06Q 30/00

(52) U.S. Cl. 705/14.49; 705/14.73

(57) ABSTRACT

A system and methods for intermediating between publishers and advertisers, wherein the system includes an advertisement database containing ads provided by numerous advertisers. Each ad entry includes the ad graphical and advertising features, and terms of use. Publishers that want to place an ad in any online, interactive public media available to the public, such as internet site owners, select an ad from the advertisement database, and after accepting the ad terms, can publish the selected ad.

### RELATED APPLICATION

The present application claims the benefit of U.S. provisional application 61/087,638 filed on Aug. 9, 2008, the disclosure of which is incorporated herein by reference.

### FIELD OF THE INVENTION

The present invention relates generally to advertising, and more particularly, to advertising systems and methods for providing a database of advertisements having pre defined features wherein a publisher can freely select the advertiser and an advertisement and place as an ad in the web site of the publisher or a media device selected by the publisher.

### BACKGROUND OF THE INVENTION AND PRIOR ART

A vast amount of data and information (referred to generally as “content”) is available via the Internet, including the world-wide web. Content can be provided from a correspondingly vast number of sources (referred to generally as “publishers”). Some of the forms which such content may take include web pages, web-sites, search results, emails and the like.

Publishers or software developer may allocate delimited spaces, typically in standard dimensions, into which advertisements, having predetermined form, substance, and other characteristics or parameters, are imported.

Several methods of placing an advertising method are commonly used in the art. Content sources, e.g., publishers, may use employees and sales departments to sell their inventories of advertisement slots, either directly or indirectly, to potential advertisers, e.g. buyers. Such advertisers generally provide the advertisement slot, such as creative material, to fill the slot they purchased from the sellers. This advertising method is suitable for well established publishers such as “NFL.com”, “AOL.com”, “CNN.com”, “Weather.com” and the like, having significant traffic of users visiting the publisher's site. Such publishers are trying to identify the “interests” of a particular visitor and direct the advertising campaign according to the determined interest.

Sometimes, a publisher may enter into a suitable written agreement with another party to sell the publisher's inventory, such as with an agency or independent sales representative.

Publishers providing search engines, such as “Google.com”, “Yahoo.com” and the like, provide word-ads that are related to keywords that the user (“visitor”) has been searching. Furthermore, the publisher can identify the user interests, for example, by using cookies.

Publishers, such as “Google.com”, may also provide a pool of advertising ads. But an end-user that wants to advertise a specific ad of a specific advertiser, cannot select such a specific ad from that pool.

Sometimes, typically unknown publishers, search for “sponsors” that will advertise in their site. For example a new shoe store that would like “Nike” to advertise in the publisher's site, and thereby generate income from the advertisement ads.

The term “visitor” as used herein refers to a random user visiting a publisher's internet web site.

There is need and it would be advantageous to have a system that facilitates advertising methods in which:
a) Publishers may obtain advertisers that will maximize the income generated from publishing an advertising advertisement.
b) Advertisers may expose advertising ads to as many visitors as possible, preferably visitors that are potential customers for the advertiser.

There is a further need and it would be advantageous to have a system that facilitates advertising methods in which an end-user can select a specific ad of a specific advertiser, selected from a pool of ads.

### SUMMARY OF THE INVENTION

The principal intentions of the present invention include providing a system and method that facilitates advertising methods in which:
a) Publishers may obtain advertisers that will maximize the income generated from publishing an advertisement.
b) Advertisers may expose advertising ads to as many visitors as possible, preferably visitors that are potential customers for the advertiser.
c) Furthermore, publishers can advertise a specific ad of a specific advertiser, selected from a pool of ads.

According to the teachings of the present invention there is provided an advertisement intermediation system including a processor and a database unit. The processor typically includes a publishers' management unit, an advertisers' management unit. The database unit typically includes a publishers' database, an advertisers' database and an ads database.

The advertisements database is operatively accessible to both advertisers and publishers, by the processor: advertisers maintain one or more stored ads on the advertisements database; and publishers select an ad from the stored ads, thereby obtaining the selected ad.

According to further teachings of the present invention there is provided an advertisement intermediation method facilitating selecting of an ad by a publisher, the publisher having an online, interactive public media for displaying the selected ad. The method includes the following steps:
a) providing an advertisement intermediation system including:
   i. a processor; and
   ii. an advertisements database, wherein the advertisements database is operatively accessible to users by the processor;
b) maintaining of one or more stored ads on the advertisements database, by an advertiser, wherein the maintaining of a stored ad may include uploading the ad, deleting the ad or updating the ad;
c) selecting an ad from the stored ads, by a publisher, thereby obtaining the selected ad; and
d) displaying the selected ad, by a publisher, on an online, interactive public media.

Uploading an ad into the advertisements database includes the steps of logging into the advertisement intermediation system by the advertiser, designating the ad to one or more online, interactive public media types, and storing the ad in the advertisements database.

In variations of the present invention, the uploading of an ad into the advertisements database further includes selecting a regional destination for the stored ads.

In variations of the present invention, the uploading of an ad into the advertisements database further includes assigning terms and conditions for using each of the uploaded ad.

The selection of an ad by a publisher includes the following steps:
a) logging into the advertisement intermediation system by the publisher;
b) selecting one or more online, interactive public media types for displaying the selected ad;
c) selecting an advertiser providing the ad;
d) selecting an ad, thereby obtaining a selected ad; and
e) accepting the terms and conditions, as set by the advertiser, for using the selected ad.

The selection of an ad, stored in the advertisements database, by a publisher, may further include the step of identifying the regional destination for the stored ads.

The selection of an ad by a publisher may further include the step of selecting a category, from a list of categories provided by the advertisement intermediation system, to which category the stored ad is associated with.

### BRIEF DESCRIPTION OF THE DRAWINGS

The present invention will become fully understood from the detailed description given herein below and the accompanying drawings, which are given by way of illustrations and examples only and thus not limitative of the present invention, and wherein:

FIG. 1 is a schematic illustration of an advertisement intermediation system, according to variations of the present invention;

FIG. 2 is a schematic flow chart showing an example method of an advertiser uploading one or more ads to the advertisement intermediation system, according to embodiments of the present invention; and

FIG. 3 is a schematic flow chart showing an example method of a publisher selecting one or more ads from the advertisement intermediation system, according to embodiments of the present invention.

### DETAILED DESCRIPTION OF THE PRESENT INVENTION

The present invention will now be described more fully hereinafter with reference to the accompanying drawings, in which preferred embodiments of the invention are shown. This invention may, however, be embodied in many different forms and should not be construed as limited to the embodiments set forth herein; rather, these embodiments are provided, so that this disclosure will be thorough and complete, and will fully convey the scope of the invention to those skilled in the art.

Unless otherwise defined, all technical and scientific terms used herein have the same meaning as commonly understood by one of ordinary skill in the art to which this invention belongs. The methods and examples provided herein are illustrative only and not intended to be limiting.

The system of the present invention provides an advertisement database containing ads provided by one or more advertisers, typically, by numerous advertisers. Each ad entry includes the ad graphical and advertising features and terms of use. Publishers that want to place a specific ad in a media available to the public, publishers such as Internet site owners or owners of other online, interactive public media, select an ad from the advertisement database, and after accepting the ad terms, can publish the selected ad in the media available to the public.

It should be noted that the present invention will be described in terms of publishing an ad in a page of an internet site of the publisher, but with no limitation upon the online, interactive public media being an Internet site. The online, interactive public media can also be selected from the group including mobile devices), display computers, television, desktop computers, electronic billboards, wireless electronic image frames, IPTV (Internet Protocol Television), tablets, devices disposed in vehicles facilitating online capabilities, closed-loop display systems, electronic books, 3D holograms, a blog, Facebook, Myspace and the like, all of which are within the scope of the present invention.

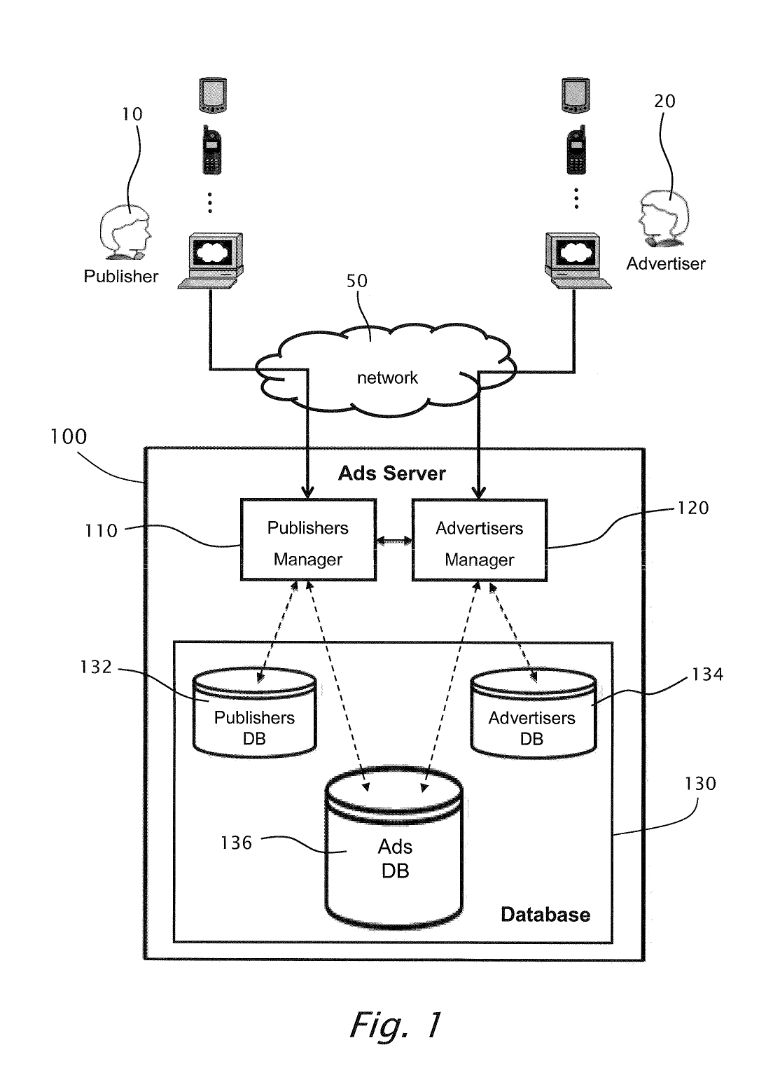

Reference is now made to FIG. 1, which is a schematic illustration of an advertisement intermediation system 100, according to variations of the present invention. Advertisement intermediation system 100 is an ads-server including publishers' management unit 110, advertisers' management unit 120 and database (DB) unit 130. Database unit 130 includes publishers' DB 132, advertisers' DB 134 and ads DB 136.

To place an ad in an Internet page, a publisher 10 logs into advertisement intermediation ads-server 100 over a network 50, such as an internet network, a cellular network or any other network, and selects an ad from ads DB 136, typically via publishers' management unit 110. To upload a new ad into ads DB 136, an advertiser 20 logs into advertisement intermediation ads-server 100 over network 50, and adds an ad into ads DB 136, typically via advertisers' management unit 120.

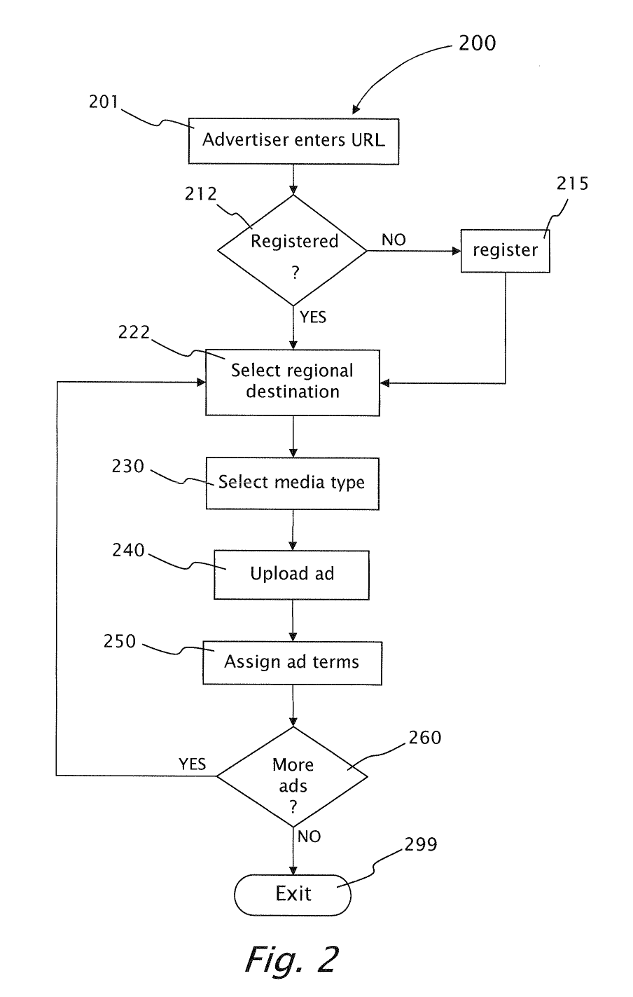

Reference is now made to FIG. 2, which is a schematic flow chart showing an example method 200 of an advertiser uploading one or more ads into advertisement intermediation system 100, according to embodiments of the present invention. Advertiser 20 logs into system 100 in step 201, in order to upload one or more ads into ads DB 136 of system 100, or update one or more ads in ads DB 136. Typically, if advertiser 20 is not a registered user of the services provided by system 100 (step 210), advertiser 20 can register to the service in step 215.

Once advertiser 20 is logged into system 100, process 200 proceeds as follows:

Step 220: select regional destination.
Optionally, advertiser 20 selects the geographical destination of the ad being uploaded. The geographical destination can be the whole world, one or more countries, one or more states/provinces/cantons, etc.
   Step 230: select the online, interactive public media type.
The new ad is designated to one or more online, interactive public media types such as a page of an internet site of the ad publisher, a mobile device, one or more displays connected to a computer, television, tablets, one or more electronic billboards, a wireless electronic image frame, IPTV, closed-loop display systems, electronic books, 3D holograms, a blog, a Facebook, a Myspace and the like.
   Step 240: upload an ad.
Advertiser 20 uploads the new ad into ads DB 136, typically via advertisers' management unit 120.
   Step 250: assign terms of use to the new ad.
Advertiser 20 assigns the terms and conditions for using the new ad by a publisher 10. The terms may include one or more of the following:
   a) the payment charged per click on the ad;
   b) the payment charged per exposure of the ad;
   c) how long will the ad be displayed;
   d) for how many exposures will the ad be displayed; and/or
   e) others.
It should be noted that different rates and methods may be provided depending on if the profile of the visitor is known or not.
   Step 260: determine if advertiser 20 wants to add another ad.
if advertiser 20 wants to add another ad, go to step 220.
Otherwise exit (step 299).

Optionally, for publishers 10 who wishes to be notified of new ads or special event, or publishers 10 having a running advertisement that wish to automatically update running advertisement, advertiser 20 may provide such services to such publishers 10.

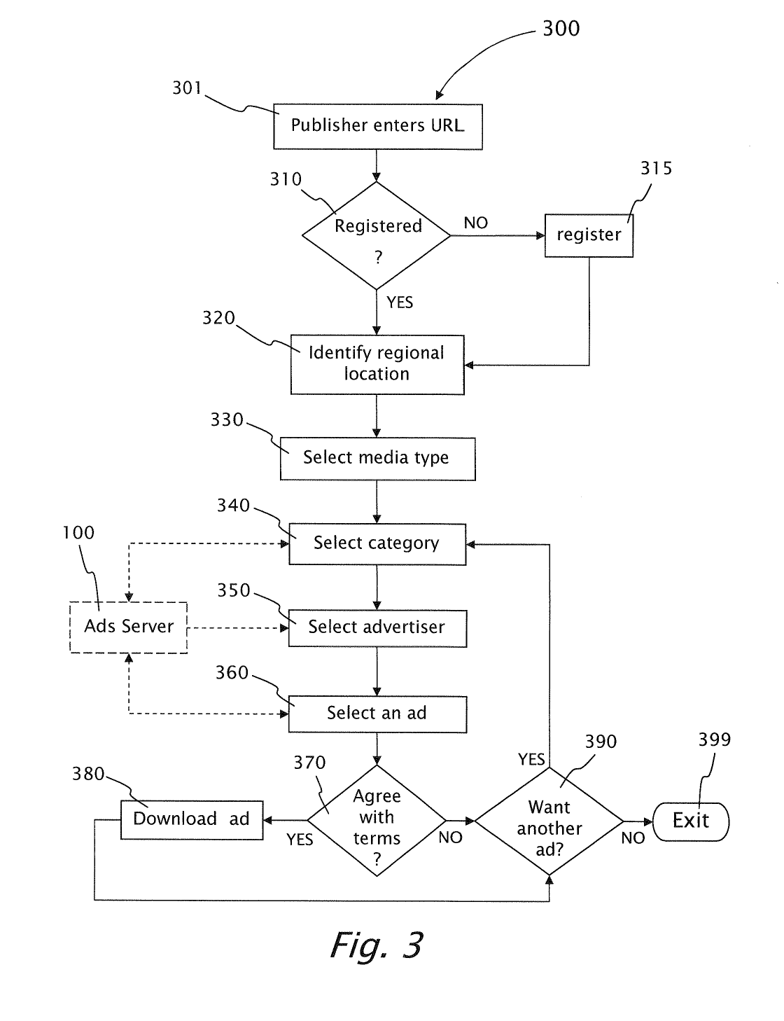

Reference is now made to FIG. 3, which is a schematic flow chart showing an example method 300 of publisher 10 selecting an advertiser one or more of the ads of the selected advertiser from advertisement intermediation 100, according to embodiments of the present invention. Publisher 10 logs into system 100 in step 301, in order to select one or more ads from ads DB 136 of system 100. Typically, if publisher 10 is not a registered user of the services provided by system 100 (step 310), publisher 10 can register to the service in step 315.

Once publisher 10 is logged into system 100, process 300 proceeds as follows:

Step 320: identify regional destination.
Optionally, publisher 10 identifies the geographical destination of the ad to be displayed. The geographical destination can be the whole world, one or more countries, one or more states/provinces/cantons, etc. The geographical destination should match the geographical destination designated by the ad to be selected in process 300.
   Step 330: select the online, interactive public media type.
The online, interactive public media type that publisher 10 owns can be a page of an internet site of publisher 10, a mobile phone, one or more displays connected to a computer, television, tablets, one or more electronic billboards, a wireless electronic image frame, IPTV, closed-loop display systems, electronic books, 3D holograms, a blog, a Facebook, a Myspace and the like.
   Step 340: select a category.
Preferably, publisher 10 selects a category from a list of categories provided by publishers' management unit 110. For example, if publisher 10 is a shoe store having an internet site, publisher 10 selects “shoe industry” category.
   Step 350: select an advertiser 20.
Publisher 10 selects an advertiser 20 and one or more ads from which publisher 10 wishes to present on the online, interactive public media owned by publisher 10. Publisher 10 selects advertiser 20 from a list typically provided by publishers' management unit 110.
   Step 360: select an ad.
Publisher 10 selects an ad from a list of adds available from advertiser 20, selected in step 350.
   Step 370: review the terms of the selected ad.
Publisher 10 reviews the terms and conditions for utilizing the selected ad, as preset by advertiser 20 (step 250).
If publisher 10 does not accept the ad terms, go to step 390.
   Step 380: publisher 10 downloads the ad.
Publisher 10 downloads the selected ad (or acquires the ad in any other way known in the art) for presentation on the destined media type.
   Step 390: determine if publisher 10 wants to select another ad.
If publisher 10 wants to select another ad, go to step 340.
Otherwise, exit (step 399).

In variations of the present invention, publishers' management unit 110 and advertisers' management unit 120 are combined into a single management unit.

The invention being thus described in terms of several embodiments and examples, it will be obvious that the same may be varied in many ways. Such variations are not to be regarded as a departure from the spirit and scope of the invention, and all such modifications as would be obvious to one skilled in the art.

What is claimed is:

1. An advertisement intermediation method facilitating selecting of an ad by a publisher, said publisher having an online, interactive public media for displaying said selected ad, said method comprising the steps of:
a) Providing an advertisement intermediation system comprising:
i. a processor; and
ii. an advertisements database, wherein said advertisements database is operatively accessible to users, such as advertisers and publishers, by said processor;
b) maintaining of one or more stored ads on said on said advertisements database, by an advertiser;
c) selecting an ad from said stored ads, by a publisher, thereby obtaining said selected ad; and
d) displaying said selected ad, by a publisher, on said online, interactive public media.

2. The method of claim 1, wherein said maintaining of said stored ads includes activities selected from the group consisting of uploading, updating and deleting.

3. The method of claim 2, wherein said uploading of said stored ads into said advertisements database comprises the steps of:
a) logging into said advertisement intermediation system by said advertiser;
b) designating said stored ad to one or more online, interactive public media types; and
c) storing said stored ad in said advertisements database.

4. The method of claim 2, wherein said uploading of said stored ads into said advertisements database further comprises the step of:
d) selecting regional destination for said stored ads.

5. The method of claim 2, wherein said uploading of said stored ads into said advertisements database further comprises the step of:
e) assigning terms and conditions for using each of said stored ads.

6. The method of claim 1, wherein said selecting of said stored ad comprises the steps of:
a) logging into said advertisement intermediation system by said publisher;
b) selecting said one or more online, interactive public media types for displaying said selected ad;
c) selecting an advertiser providing said stored ad;
d) selecting said stored ad, thereby obtaining said selected ad; and
e) accepting the terms and conditions for using said selected ad.

7. The method of claim 6, wherein said selecting of said selected ad comprises the step of:
f) identifying the regional destination for said stored ads.

8. The method of claim 6, wherein said selecting of said selected ad comprises the step of:
g) selecting a category from a list of categories provided by said advertisement intermediation system.

9. An advertisement intermediation system facilitating selecting of an ad by a publisher, said publisher having an online, interactive public media for displaying said selected ad, said system comprising:
a) a processor; and
b) an advertisements database,
wherein said advertisements database is operatively accessible to users, such as advertisers and publishers, by said processor;
wherein one or more advertisers maintain one or more stored ads on said advertisements database; and
wherein said publisher selects an ad from said stored ads, thereby obtaining said selected ad.
